(19) United States
(12) Patent Application Publication
(10) Pub. No.: US 2023/0384888 A1
(43) Pub. Date: Nov. 30, 2023

(54) TOUCH DISPLAY

(71) Applicant: Lumineq Oy, Espoo (FI)

(72) Inventors: Jussi PIRKKALANIEMI, Espoo (FI); Jonne LINDEBERG, Espoo (FI)

(21) Appl. No.: 18/030,831

(22) PCT Filed: Oct. 8, 2021
(86) PCT No.: PCT/FI2021/050665

§ 371 Date: Apr. 7, 2023

(30) Foreign Application Priority Data
Oct. 9, 2020 (FI) 20205991

(51) Int. Cl. G06F 3/041; G06F 3/044

(52) U.S. Cl. CPC G06F 3/04166; G06F 3/0412; G06F 3/0445; G06F 2203/04107

(57) ABSTRACT

A touch display (100) is disclosed. It comprises a transparent thin film display element (100a) comprising a first and a second patterned conductor layer (100b, 100c) with common and segment display electrodes (106, 107) and touch electrodes (101). The touch display also comprises a driving electronics unit (210) comprising driving circuit nodes (110, 215, 216), and a touch measurement unit (200). The touch display (100) comprises an electric connection (251) between the shield signal node (206) of the touch measurement unit (200) and a driving circuit node (110, 215, 216) of the driving electronics unit (210) arranged to couple the shielding voltage signal (206s) to the driving circuit node (110, 215, 216).

### FIELD OF THE INVENTION

The present invention relates to a touch display, and more particularly to a touch display according to the preamble of claim 1.

### BACKGROUND OF THE INVENTION

Touch displays are getting more and more commonplace in making a two directional user interface for various devices and structures, enabling both user input and output to the user. For example, in mobile phones, touch displays are currently ubiquitous. Also displays that are integrated into the external windows in vehicles like cars and tractors are getting more and more commonplace. For example, it is possible to laminate a transparent window to the windshield of a tractor for the indication of various states and warning conditions related to the operation of the tractor. Also projected HUDs are well known in the marketplace.

With touch sensing capability, the display becomes a two-way interface for the user. One example of an use case of such a touch display is a so-called pin-pad application where a keyboard with numbers 0-9 and some additional marks like hash (“#”) and asterisk (“*”) are combined with a display. Such a touch display can be integrated into the side window of a car, enabling keyless entry to the vehicle as the user can be granted access when a correct PIN number is entered. A laminated window-pane of a vehicle is a very advantageous location for a touch display. When located into the interlayer of a two-ply laminate or in a recess in the interlayer, the display is very well protected from the environment, mechanical wear and tear, and other impacts. Naturally, the touch display (which is usually a glass or plastic substrate on which a complex thin film structure is fabricated and comprising electric connections usually in a form of an FPC (flexible printed circuit) or other flat cable) or at least portions of it has to be able to withstand the glass lamination manufacturing process step that reaches easily 140 C. temperatures and 10 bar pressures. Usually, the display also comprises driving and sensing electronics creating the light producing signals, sense the touch events and communicate with other electrical systems with input and output signals. At the same time, the laminated window and laminated display therein must fulfil the relevant standards and safety aspects for vehicle glazings, e.g. standards related to the transparency and shattering characteristics.

One of the problems associated with the prior art is related to the use conditions of a transparent touch display integrated into an external vehicle window, e.g. car side window. Touch event is registered in the prior art technology usually with capacitive sensing in which a chance in a coupling capacitance or self-capacitance of an electrode or electrodes is detected. Said change is invoked by the presence of an operator touching, usually with his or her finger or fingers, the touch display. Human tissue is complex combination of electrically conducting and insulating microscopic and macroscopic regions, with different, usually frequency dependent permittivity and conductivity. However, unfortunately from the perspective of the touch detection, water resembles human tissue in the electromagnetic sense. Thus, a drop or a splash of water on the top of the touch display is difficult to tell apart from the real touch event by the user of the display. Also other exposures like mud, dirt, snow or slush or any combination thereof on top of the display are difficult to distinguish from real user touch interaction. Ability to distinguish between real user touch and environmental exposure is usually called “immunity” in the art, and as most of the environmental exposure is due to drops, streams, ropes or splashes of liquid water on top of the touch display, this ability is called “water immunity” even though the exposure can be due to e.g. dirt or slush, too. As part of a good water immunity, true touch events are recognized even in presence of environmental factors on top or in the immediate vicinity of the touch display.

Good water immunity is not easy to achieve. In the prior art, solutions thereto are difficult to arrange, involve complex structures and/or method steps, and increase the overall cost and energy consumption of the touch display.

Thus, there is a need to improve the water immunity of a touch display, especially when the touch display is integrated into the exterior of a vehicle, e.g. laminated into an external window of the vehicle.

### BRIEF DESCRIPTION OF THE INVENTION

An object of the present invention is to provide a touch display with improved water immunity. In particular, the objects of the invention are achieved by a touch display according to the independent claim 1.

The preferred embodiments of the invention are disclosed in the dependent claims.

According to an aspect of the present invention, a touch display comprises a transparent thin film display element extending substantially along a base plane defining a lateral extension of the transparent thin film display element. The transparent thin film display element comprises an emissive layer arranged to emit light upon an excitation voltage is arranged over the emissive layer, a first patterned conductor layer on a first side of the emissive layer, first patterned conductor layer comprising a segment display electrode, and a second patterned conductor layer on a second side of the emissive layer opposite the first side of the emissive layer, comprising a common display electrode at least partly laterally overlapping the segment display electrode. The touch display further comprises a touch electrode, and a driving electronics unit. The driving electronics unit comprises: a segment driving node arranged to produce a segment driving signal to the segment display electrode, a common driving node arranged to produce a common driving signal to the common display electrode, and a driving electronics ground node. The touch display further comprises a touch measurement unit comprising: a touch measurement node arranged to provide a touch measurement signal for touch detection, a shield signal node arranged to provide a shielding voltage signal arranged to decrease capacitive coupling, and a touch ground node. The touch display comprises further a first electrical conductor arranged to electrically connect the segment display electrode and the segment driving node, a second electrical conductor arranged to electrically connect the common display electrode and the common driving node, a third electrical conductor arranged to electrically connect the touch electrode and the touch measurement node, and an earth ground node. According to an aspect of the invention, the touch display comprises an electric connection between the shield signal node of the touch measurement unit and a driving circuit node of the driving electronics unit arranged to couple the shielding voltage signal to the driving circuit node. A driving circuit node may be any circuit node in the driving electronics unit, for example the segment driving node, the common diving node or the touch ground node. Above, “arranged to couple” means that an electric connection possibly comprising circuit elements or components like a switch or a capacitor is arranged between the circuit nodes. Such circuit elements or components may be controlled by other elements of the touch display. The driving circuit nodes of the display are an advantageous and surprising location for distributing shield signal to the display panel or element.

According to an embodiment, touch display comprises the electric connection between the shield signal node of the touch measurement unit and a common driving node of the driving electronics unit. According to an embodiment, touch display comprises the electric connection between the shield signal node of the touch measurement unit and a segment driving node of the driving electronics unit. According to an embodiment, touch display comprises the electric connection between the shield signal node of the touch measurement unit and a driving electronics ground node of the driving electronics unit. Again, said circuit nodes of the display are an advantageous and surprising location for distributing shield signal to the display panel or element.

More generally, in an embodiment, touch display comprises the electric connection between the shield signal node of the touch measurement unit and one or more common driving nodes of the driving electronics unit. Alternatively, the touch display comprises the electric connection between the shield signal node of the touch measurement unit and one or more segment driving nodes of the driving electronics unit. Alternatively, the touch display comprises the electric connection between the shield signal node of the touch measurement unit and one or more driving electronics ground nodes of the driving electronics unit. Again, the driving circuit nodes of the display are an advantageous and surprising location for distributing shield signal to the display panel or element.

According to an embodiment, the electric connection comprises a shield signal capacitor. According to another embodiment, the electric connection comprises a shield signal capacitor with a capacitance of at least 5 pF. According to another embodiment, the electric connection comprises a shield signal capacitor with a capacitance between 1 pF and 1 uF; or with a capacitance more preferably and 100 nF; or with a capacitance and most preferably 100 pF and 10 nF. A shield signal capacitor suitably large is able to push the shield signal to the thin film structure of the display where it increases the water immunity.

According to an embodiment, the touch display comprises a switch that is arranged to turn an electric connection between the shield signal node of the touch measurement unit and the driving circuit node of the driving electronics unit into: an open state during light emission periods, and a closed state during touch measurement periods. It is advantageous to perform the measurements of touch, that is, touch determination and light emission at different time periods, and to help in this, a switch synchronized with the touch measurement/light production periods is advantageous.

According to yet another embodiment, the first patterned conductor layer on a first side of the emissive layer comprises a fill area, and the touch display comprises a fourth electrical conductor arranged to electrically connect the fill area and the shield signal node and to couple the shielding voltage signal to the fill area. Fill area also helps in making the display more uniform optically, and driving shield signal thereto helps in achieving a better water immunity.

According to an embodiment, the driving electronics unit comprises a shield signal enabling node which is electrically connected to the switch and arranged to provide a control signal, the control signal arranged to control the open state and the closed state of the switch. Driving electronics unit is one suitable location of control.

According to yet another embodiment, the touch display comprises a control unit arranged to control:

a) the driving electronics unit, as controlled by the control unit, arranged to produce a driving signal to the segment display electrode and to the common display electrode for light emission during light emission periods,

b) the touch electronics, as controlled by the control unit, arranged to produce, during touch measurement periods, the touch measurement signal to the touch electrode for touch detection, and the shielding voltage signal; and

c) the switch, as controlled by the control unit, arranged to connect the shield signal node to the driving circuit node of the driving electronics unit during touch measurement periods, and disconnect the shield signal node from the driving circuit node of the driving electronics unit during light emission periods. A control unit external to the driving electronics unit and touch electronics is advantageous if the driving electronics unit is a mass-produced catalogue component that cannot perform the said control function.

According to another embodiment, the first patterned conductor layer on a first side of the emissive layer comprises the touch electrode. According to another embodiment, the second patterned conductor layer on a second side of the emissive layer comprises the touch electrode. According to yet another embodiment, the first patterned conductor layer on a first side of the emissive layer comprises a touch electrode, and the second patterned conductor layer on a second side of the emissive layer comprises another touch electrode. Touch electrodes can be readily placed on both layers, their location is determined mostly from the side of the touch events in the use scenarios.

According to yet another embodiment, the transparent thin film display element comprises a third patterned conductor layer, and the third patterned conductor layer comprises the touch electrode. The touch electrode can also be placed outside the normal display electrode structure, e.g. outside the TFEL thin film stack usually employed with separate layers for common and segment electrodes.

According to another embodiment, the first patterned conductor layer comprises one or more segment display electrodes, the driving electronics unit comprises one or more segment driving nodes, and the touch display comprises one or more first electrical conductors arranged to electrically connect the one or more segment display electrodes and the one or more segment driving nodes. There can naturally be any number of segment electrodes.

According to another embodiment, the second patterned conductor layer comprises one or more common display electrodes, the driving electronics unit comprises one or more common driving nodes, and the touch display comprises one or more second electrical conductors arranged to electrically connect the one or more common display electrodes and the one or more common driving nodes. There can naturally be any number of common electrodes.

According to yet another embodiment, the touch display comprises one or more touch electrodes, the touch measurement unit comprises one or more touch measurement nodes arranged to provide a touch measurement signal for touch detection, and the touch display comprises one or more third electrical conductors arranged to electrically connect the one or more touch electrodes and the one or more touch measurement nodes. There can naturally be any number of touch electrodes.

The invention is based on the idea of providing the touch display with an arrangement that provides so-called shield signal or shielding voltage signal to the circuit node of the light generating portion of the display electronics. Through this arrangement of the touch display, the presence of spurious objects like splashes of water can be eliminated or at least alleviated from the touch sensing of the touch display.

An advantage of the invention is that the water immunity of the touch display is considerably improved with a feasible circuit topology that does not affect other functions of the display negatively.

### BRIEF DESCRIPTION OF THE DRAWINGS

The invention is described in detail by means of specific embodiments with reference to the enclosed drawings, in which

FIG. 1 shows schematically a prior art touch display and its peripheral objects,

FIG. 2 shows schematically a prior art touch display,

FIG. 3 shows schematically a portion of a prior art touch display under environmental exposure,

FIG. 4 shows schematically a prior art touch display under environmental exposure driven with a shield signal,

FIG. 5 shows schematically a prior art touch display under a major environmental exposure,

FIG. 6 shows schematically a touch display according to an embodiment of the current invention under a major environmental exposure,

FIG. 7 shows schematically a touch display according to another embodiment of the current invention under a major environmental exposure,

FIG. 8 shows schematically a touch display according to another embodiment of the current invention under a major environmental exposure, and

FIG. 9 shows schematically a touch display according to yet another embodiment of the current invention under a major environmental exposure.

### DETAILED DESCRIPTION OF THE INVENTION

In the following description, like numbers (e.g. 20) or labels (e.g. 21a) denote like elements. The following definitions also apply in the present application throughout:

A “display” means an electronic device configured to present data, state or imagery. The display is arranged to display various patterns as pixels, images, or text, but also, for example, indicator displays or user interface elements with at least one emissive area for light emission from the emissive area. In other words, a “display” is arranged to output information through light emission.

A “display panel” means the portion of the display which comprises the at least one light emissive area like overlapping segment and common display electrodes

A “touch display panel” means the portion of the display which comprises the at least one light emissive area like overlapping segment and common display electrodes, and a touch sensing area comprising a touch electrode.

A “touch display” means a display arranged, in addition to displaying information, to detect user interaction with the display in form of touch or close vicinity relative to the touch display, by part of the body of the user (e.g. finger or elbow) or by a peripheral like a stylus.

A “touch” means any change in distance between a pointing object, such as a finger of the user of the touch display, and a touch electrode resulting in a detectable change in self-capacitance between said pointing object and said touch electrode. Usually a “touch” means brining the pointing object to a close proximity to the touch electrode, e.g. a situation where only an insulator over the display panel like the interlayer film and glass ply separate the pointing object and the electrode. Such a separation can be, for example 0.5 mm-3 mm. As such, “touch sensing” may herein refer to touch and/or proximity sensing.

A “display arrangement” refers to an arrangement which may form a complete, operable display. Alternatively, a display arrangement may be used as a part of a complete display comprising also other elements, units, and/or structures. A display arrangement may generally comprise at least one display element.

A “display element” refers to an element comprising at least one emissive area for emitting light therefrom to present visual information.

“Light” refers to electromagnetic radiation of any wavelength(s) within a range of relevant wavelengths. The range of relevant wavelengths may overlap or coincide with ultraviolet (wavelength from about 10 nanometres (nm) to about 400 nm), visible (wavelength from about 400 nm to about 700 nm), and/or infrared (wavelength from about 700 nm to about 1 millimetre (mm)) parts of electromagnetic spectrum.

A “layer” means a generally sheet-formed element arranged on a surface or a body. A layer can also refer to one of a series of superimposed, overlaid, or stacked generally sheet-formed elements. A layer may generally comprise a plurality of sublayers of different materials or material compositions. A layer may be path-connected. Some layers may be locally path-connected and disconnected and have one or more holes.

In this disclosure, a “base plane defining the lateral extension of the transparent thin film display element” means that the display element has lateral directions along said base plane. Lateral directions of said element usually has dimensions substantially larger than in a thickness direction perpendicular to said lateral directions.

Herein, a “thin film display element” refers to a display element comprising layers that have thicknesses, for example, in a range from a few nano metres to some hundreds of nanometres or some micrometres. The thin film display element may also comprise a substrate, substrate usually comprising glass or ceramic material, on top of which the thin films are deposited or otherwise arranged. The thin film display element may also comprise a cover glass on the other side of the substrate.

An “emissive layer” refers to layer comprising material capable of emitting light when an driving signal or driving voltage is coupled over said emissive layer. Here, “over the emissive layer” means that a voltage is applied between the two surfaces of the emissive layer. Said application of voltage is usually arranged by light producing electrodes, in particular segment display electrodes and common display electrodes arranged on opposite sides of the emissive layer.

An “excitation voltage” means a high enough voltage to achieve a wanted level of light emission from the emissive layer. An excitation voltage in the thin film inorganic electroluminescent displays (also called “TFEL displays”, or “TFELs”) is in the order of 50V-250V in amplitude, and comprise pulses or, in general, AC (alternating current and voltage) excitation. For OLED (organic led) displays, another important class of emissive displays comprising thin films, the excitation voltage is usually in the range of 2-10V only.

A “conductor” may mean an electrical conductor material and/or the electrical conductivity thereof and/or a physical shape (e.g. line or trace) of substantially electrically conducting material. Consequently, a “conductor layer” means a layer comprising a conductor material. A conductor may also mean a cable, e.g. a flat cable or flat printed circuit suitable of conveying one or more voltage or current signals with suitable insulators between the conductive traces or wires.

The concept of “transparent” means a quality, i.e., “transparency”, of said element or material of allowing light of wavelength(s) within a range of relevant wavelengths to propagate through such element or material so that, for example, the sight of vision is not materially hindered with relation to the view behind the material. Said range of relevant wavelengths may generally depend on intended usage of such transparent element or material. No real material is 100% transparent as every material has at least small attenuating and reflective characteristics relative to an ideal free space.

A “light electrode” or “light producing electrode” means an electrode, usually a planar conductive, thin area or “patch” suitable for coupling electrical voltage or driving signal over an emissive layer for light emission. A display electrode may be functionally, electrically, and/or galvanically connected to a display driver unit for the coupling of said electrical voltage. A display electrode may at least partly or entirely overlap another display electrode laterally to couple electrical voltage over an emissive layer. Common display electrodes and segment display electrodes are both light producing electrodes as their overlapping area, when supplied with a driving signal, produces light according to the principles of TFEL displays.

A “touch electrode” means an electrode, usually a planar conductive, thin area or “patch” which, when arranged with suitable touch sensing unit or touch measurement unit and touch measurement signals, contributes to sensing a change in capacitance of the touch electrode relative to another electrode or area, surface or object where the electric field lines from the touch electrode start or end, or relative to infinity or other suitably far-away object or location.

A “self-capacitance” of an element means a physical quantity of a non-insulating body, for example a touch electrode, indicative of a ratio between added electrical charge in said body and an increase in electrical potential or voltage of said body. Measurement of self-capacitance may be referred to as measurement of capacitance with respect to infinity. In practice, measurement of self-capacitance may refer to measuring capacitance with respect to an electrical ground, e.g., earth ground.

A “shielding voltage signal” means a signal, which may be time-dependent and when fed to a circuit node like a conductor area, is suitable for decreasing capacitive coupling between a touch electrode and a conductor area. Such a conductor area may be e.g. another electrode. Additionally or alternatively, a shielding voltage signal may refer to a signal with a sufficient cross-correlation with a measurement voltage signal. In practice, supply of measurement and shielding voltage signals by a touch measurement unit described in more detail below. Suitable signal types may generally depend on a variety of factors, including thin film display element type, structure of the emissive layer, and economical considerations. In some embodiments, sinusoidal and/or square voltage signals or square pulse trains or bursts may be used as measurement and/or shielding voltage signals.

In the present application, “an electric connection” or “electrical connection” means that two circuit nodes or two circuit elements are arranged to be interconnected purposefully, with not just a parasitic coupling between the circuit nodes or circuit elements. The electrical connection may comprise other circuit elements or components in series or in parallel. An electrical connection may also be a short circuit or a low-impedance coupling or a galvanic connection between the two circuit nodes or two circuit elements.

In the present application, a “node” or a “circuit node” means the electric circuit theory concept of a conducting region having essentially the same potential or voltage, between at least two circuit elements. E.g. a conductor (e.g. a copper wire in an FPC) connected to a driving circuit node are the same driving circuit node as the driving circuit node determines the voltage of the conductor throughout the region of the conductor.

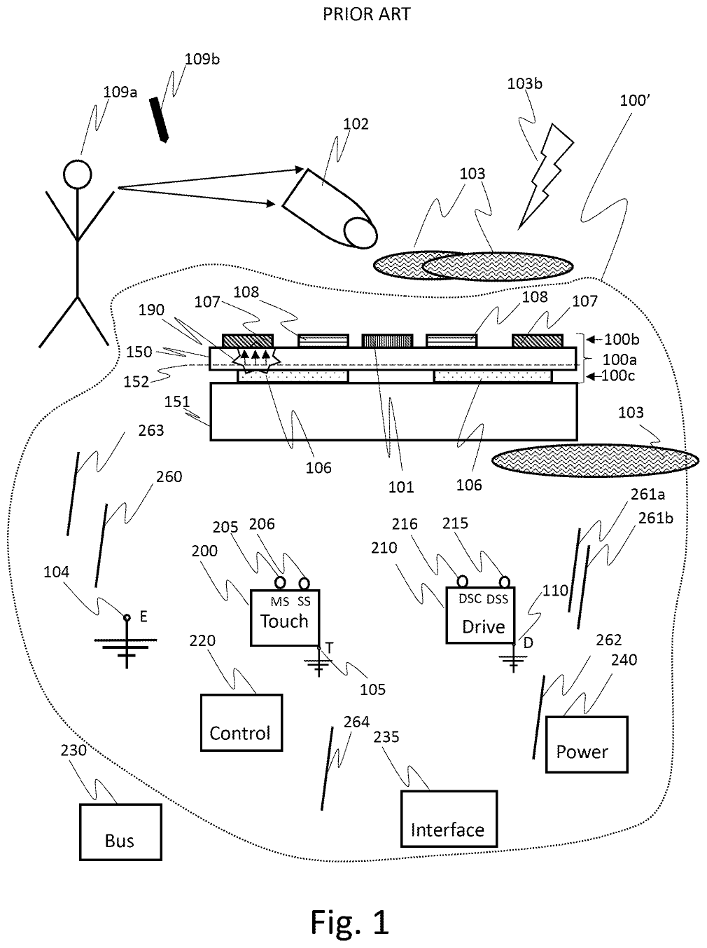

FIG. 1 shows basic units in a prior art touch display 100′ schematically.

The touch display 100′ comprises a substrate 151 and a thin film structure comprising one or more common display electrodes 106, one or more segment display electrodes 107, an emissive layer 150 that, when suitably excited with voltage over the emissive layer, emits light at the lateral overlap of the two electrodes providing the excitation (here, segment display electrodes 107 and common display electrodes 106), one or more fill areas 108 and one or more touch electrodes 101. Emissive layer may comprise e.g. manganese doped zinc sulfide (ZnS:Mn). Dimensions of the units in FIG. 1 are exaggerated as the thickness of the various electrodes and emissive layer are several orders of magnitude smaller than the thickness of the substrate. Light emission occurs when light producing electrodes (that is, at least one common electrodes 106 and at least one segment display electrode 107) are at least partially arranged to overlap in the lateral direction (segment display electrode 107 and common display electrode 106, as shown), relative to one another, and when the electrodes 106 and 107 are fed with a common driving signal and a segment driving signal, respectively. The segment driving signal and the common driving signal each have voltage and current characteristics arranged to excite the emissive layer for light emission 152 or leave it dark, depending on the information displaying task at hand. Driving signals are generated by driving electronics unit 210, and each of the light producing electrodes, common display electrodes 106 and segment display electrodes 107, is coupled to the drive electronics with suitable conductors 261a and 261b, respectively.

If the segment display electrodes 107 and common display electrodes 106 are transparent, e.g. made of a transparent conductive oxide like indium doped tin oxide (“ITO”), the display is transparent. In TFEL displays, a first electric insulator layer between the segment display electrodes 107 and the emissive layer 150 is usually provided. Similarly, in TFEL displays, a second electric insulator layer between the common display electrodes 106 and the emissive layer 150 is usually provided. First and second electric insulator layers are provided to block a high direct current running which would likely ruin the display. First and second insulator layers are usually transparent, as is the emissive layer 150. Thus, the transparency of the display is determined mostly by the properties of the electrode layers (that is, first and second patterned electrode layers).

Purpose of the fill area 108 is to improve the optical appearance and uniformity of the display. Electrodes (for example, light producing electrodes 106 and 107 and touch electrodes 101) are thin film structures and they do not cover the entire surface area of the display. Transmission and reflectivity at the areas with electrodes and at the areas with no electrodes differ, making the display surface appear nonuniform. This problem can be corrected to a large degree by deposition (or if the layer is patterned with etching, non-etching) of one or more fill areas 108 that are not fed with driving or measurement signals and are as inert as possible from the standpoint of electrical operation of the display, but from the material and optical point of view correspond or appear like electrodes and are provided from the same conductive material as electrodes, e.g. ITO. However, as will be discussed later in the present application, the fill areas act as (parasitic) capacitors in the overall system of the display as they comprise mostly conductive material just as the other electrodes do.

Touch event can be detected when a part, here a finger 102, of the user body is brought to the proximity of touch electrode 101. Detection is based in the change of capacitance of the touch electrode 101 caused by the introduction of finger 102 into the vicinity. The finger 102 can be seen to introduce a parallel capacitor to the system of the touch electrode 101 originally having a certain capacitance relative to the surrounding, thus increasing the sensed capacitance of the touch electrode 101. With a suitable touch measurement unit 200 and measurement signals generated by the touch measurement unit or touch sensing electronics, this change can be detected. Detection of the change in capacitance requires that the sensing electrode is connected with suitable conductors 260 to the touch sensing electronics and its measurement node or nodes 205 (to simplify FIG. 1, exact connections between the different units is not shown). For each of the touch electrodes 101, a separate conductor 260 and a separate measurement node 205 in the touch measurement unit 101 may be provided. Challenge with prior art is that many environmental exposures like splashes of water, mud or slush, shown with symbol 103, can also find their way to the surface of the touch display and also alter the capacitance of the touch electrode 101. Similarly, spurious electromagnetic fields around the touch display, represented with symbol 103b, can be interpreted as a change in capacitance of the touch electrode 101, leading to a false touch sensing and wrong consequences based on the interpretation of the false touch. For a display laminated into a vehicle exterior window, the environmental exposure can naturally occur from the outside of the vehicle, but such exposure is also theoretically possible from the inside of the vehicle if e.g. rain water seeps into the car cabin and onto the inside surface of a side window of a car or a e.g. drink is spilled on the side window by accident. Interaction with the touch display can be performed with any part of the user body 109a, or with a stylus 109b held and operated by the user.

For a skilled person it is evident that the prior art touch display 100′ comprises a power unit 240 that supplies the power to the operations of the touch display 100. Power supply is provided with suitable conductor or conductors 262. Further, the prior art touch display 100′ comprises an interface unit 235 which communicates in a two-way sense with both input and output with the system units external to the prior art touch display 100′ through some communication bus 230. In the present application, an interface unit 235 means both the physical connector like RJ45 and the related communication protocol like CanBUS, RS485, SPI or I2C. Similarly, communication bus 230 means both the conductors and cabling of the communication bus 230, and the logical protocol like CanBUS or RS485 carried by the conductors and cabling. The operation of the touch display can be controlled by a control unit 220, which is arranged in connection with other units like touch measurement unit 200, driving electronics unit 210, interface unit 235 and power unit 240 with suitable conductor or conductors 263.

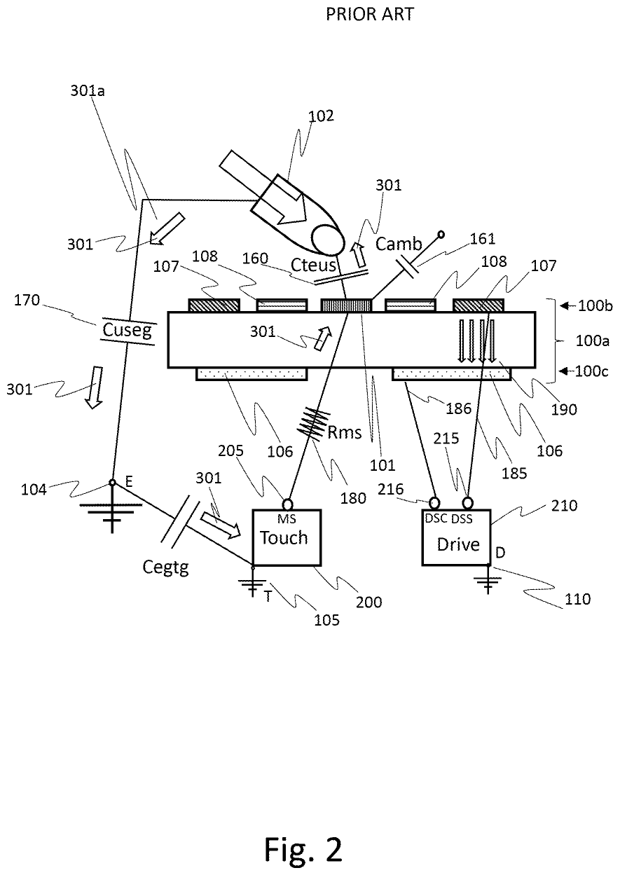

It is evident for a skilled person that the touch measurement unit 200, driving electronics unit 210, control unit 220, interface unit 235 and power unit 240 can be separate physical entities with their own housing or real estate in a printed circuit board and realized with discrete circuit components. Alternatively or additionally, the touch measurement unit 200, driving electronics unit 210, control unit 220, interface unit 235 and/or power unit 240 can be arranged with known integrated circuit technologies into a semiconductor chip, and/or realized programmatically through e.g. ASIC, FPGA and/or microprocessor and memory technologies. Turning to FIG. 2, the figure shows a prior art capacitive touch sensing event where a part of the user 102 is brought to the vicinity of the touch electrode, part of the user represented here with a symbol of a finger, arrow therein representing the aspect of movement and introduction. For brevity, symbol 102 called from hereon, the “user” or “finger” meaning the same thing, part or peripheral of a user interacting with the touch display 100. Touch electrode 101 has capacitance Camb 161 with relative to the surroundings before user 102 is introduced. When user 102 is brought to the proximity of the touch electrode 101, it forms a capacitance Cteus 160 between the user 102 and the touch electrode. Here, “teus” means a capacitance between touch (“t”) electrode (“e”) and the user (“us”). User 102 is in capacitive contact with the earth ground node 104 with capacitance Cuseg (user—earth ground) 170. Earth ground node 104 is capacitively (but not necessarily galvanically) in contact with the touch ground node 105 of the touch measurement unit 200 with capacitor Cegtg marked with symbol 171. Touch measurement unit 200 generates the touch measurement signals via a touch measurement node (MS) 205 and a third electrical conductor 180 comprising usually a series resistance of some tens or hundreds of ohms to the touch electrode 101. Thus, a circuit loop 301a marked with small arrows 301 is created. This circuit loop changes the capacitance of the touch electrode 101 so that a touch event can be sensed by the touch measurement unit 200, touch event usually increasing the capacitance when compared to a situation with no touch.

It is to be understood that the user 102 does not physically quite touch the surface of the conducive touch electrode 101, as the electrode structure is usually covered with insulating, protective thin films, and the entire touch display 100 or at least the light producing and touch sensing element part of it may be embedded for example into the interlayer of a laminated vehicle window. However, from the physiological sense, user usually senses a touch, as part of the body of the user (like finger) may physically touch the region in the immediate vicinity of the electrode.

FIG. 2 also illustrates the light emission by common display electrodes 106 and segment display electrodes 107. Driving electronics unit 210 generates, through its drive nodes 215 (only one shown), and 216 (only one shown) segment driving signals and common driving signals that cause light emission 190 when the signals are connected to segment display electrodes 107 and common display electrodes 106, respectively, through suitable conductors 186 and 185. In FIG. 2 it is also illustrated that the touch display comprises fill areas 108 that are arranged to make the surface of the touch display appear more uniform. Voltage from a segment display electrode 107 to the laterally overlapping area of a common display electrode 106 determines if light is produced or not. Said voltage is usually arranged in form of pulses with amplitude of e.g. 195V to reach adequate light output from the emissive layer 150. Similarly, for any emissive layer 150 there is an emission threshold voltage under which no light output occurs. This voltage may be e.g. 140V.

In all, FIG. 2 illustrates the structure and functionality of the touch display in a undisturbed situation with no external or environmental exposures like rain water or splashes of mud over the surface of the touch display panel, hampering the touch detection and the overall functionality of the touch display.

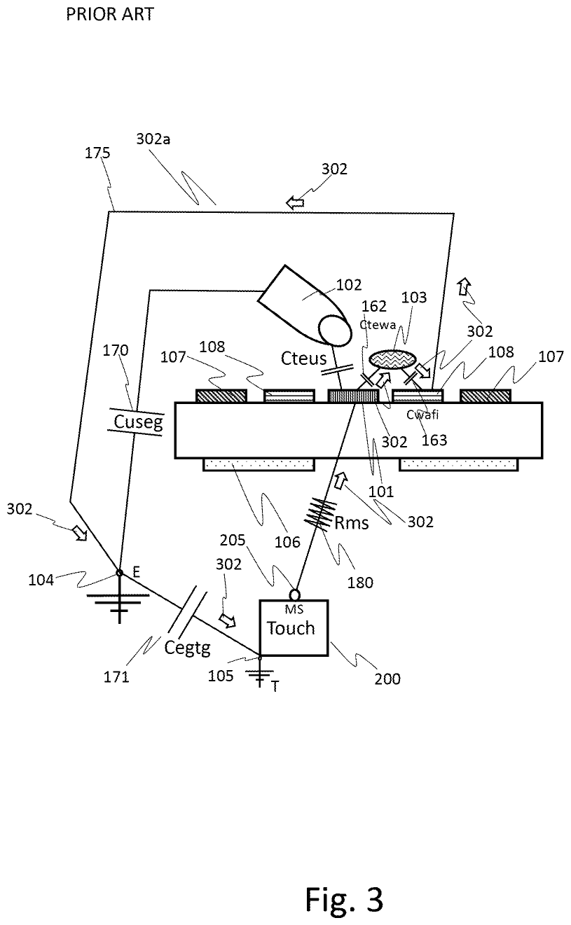

FIG. 3 illustrates the challenges related to the environmental exposure (here a splash of water 103) and touch detection in a prior art touch display. In addition to the circuit loop 301a shown in FIG. 2, additional circuit loop 302a marked with small arrows 302 affecting the touch electrode's capacitance is generated due to the splash of water 103 that reaches a grounded fill area 108. Circuit loop 302a comprises a capacitance Ctewa 162 between the touch electrode 101 and the splash 103, capacitance Cwafi 163 between the splash 103 and the fill area 108 and ground connection to earth ground node 104. Capacitance Cegtg 171 is formed from earth ground node 104 to touch ground node 105 of the touch measurement unit 200. Finally, touch measurement unit 200 and its touch measurement node 205 connected to the touch electrode 101 complete the circuit loop 302a. For touch detection, the splash of water cannot be told apart from a real touch by the user as the capacitive effect and the return path of the circuit loop 302a and its electrical behaviour is similar to circuit loop 301 in FIG. 2. It is to be noted that leaving the fill areas 108 not coupled to the earth ground will lead to other problems, in particular a strong coupling of spurious electromagnetic signals ever-present around the touch display and to the touch electrodes 101 via the surrounding fill areas 108. Thus, leaving fill areas to a “floating” potential is not a practical option, but instead grounding to the earth ground or other ground referenced DC level may be arranged.

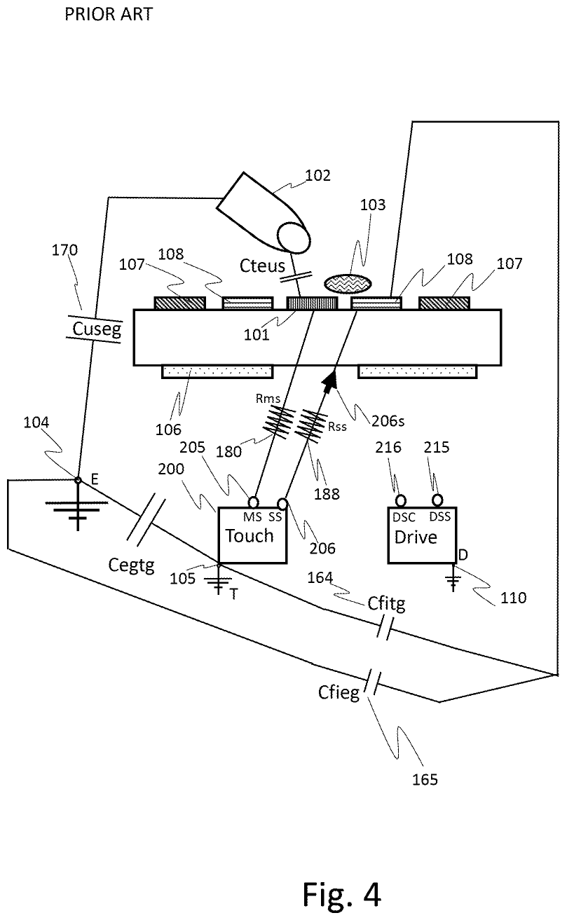

FIG. 4 shows a prior art arrangement for enabling touch detection in the presence of a small splash of water (e.g. a drop) over the fill areas and touch electrode areas. Here, a shielding voltage signal is fed to the one or more fill areas 108. Touch measurement unit 200 comprises two types of output nodes: one or more a touch measurement nodes 205 and one or more shield signal nodes 206.

The touch measurement node 205 is arranged to send a measurement signal to the touch electrode to detect a change in the capacitance. For example, the touch electronics can comprise a delta-sigma (or sigma-delta) circuit topology for touch detection, arranged for touch detection in ways known to a skilled person.

Shielding voltage signal is a signal or voltage waveform that is sufficiently “similar” to the touch measurement signal in its voltage behaviour. By exciting two conductive areas like electrodes with same or similar voltages, there is no electric field between the conductive areas, or the electric field is at least reduced between the electrodes. Thus, the two electrodes become insensitive to one another and the change in permittivity near or over one electrode (due to introduction or removal of, for example, a finger, into the vicinity of the electrodes) does not change the electric field between the electrodes. In FIG. 4, touch measurement unit 200 is arranged to apply measurement signal from node 205 (MS) to the touch electrode 101 through a slightly resistive third electrical conductor 180, and shielding voltage signal from node 206 (SS) to fill area 108 through a slightly resistive fourth electrical conductor 188. Said slight resistivity is mainly due to the somewhat limited conductivity of the patterned conductor layers 100b and 100c.

Similarity of two signals can be stated accurately with a signal cross correlation coefficient cs. Signal cross correlation may be considered a measure indicative of shape or phase similarity between two signals.

A cross-correlation coefficient cs of two discrete time signals x[t] and y[t] (t=1 . . . n) can be defined as follows:

$$cs ( x , y ) = \frac{{\sum }_{i = 1}^{n} x [ i ] y [ i ]}{\sqrt{{\sum }_{j = 1}^{n} x [ j ] x [ j ] \times {\sum }_{k = 1}^{n} y [ k ] y [ k ]}} .$$

Under practical circumstances, many signals may be treatable as discrete-time signals. In case of continuous signals, a cross-correlation coefficient cs may be calculable by sampling said signals with a sufficiently high number of samples.

In the present application, the cross correlation between the measurement voltage signal and the shielding voltage signal is at least 0.8, more specifically 0.99. In other embodiments, a signal cross-correlation coefficient may be less than 0.8, or at least 0.8, or at least 0.9, or at least 0.95. Said cross correlation may be determined as a voltage between two areas of the thin film structure (e.g.

one touch electrode 101 and one and fill area 108) or two circuit nodes (e.g. shield signal node 206 and driving electronics ground node 110). Off-the-shelf devices and component sets arranged to generate a touch measurement signal and a shielding voltage signal to decrease capacitive coupling are commercially readily available e.g. from Microchip Inc, Analog Devices Inc and from Cypress

Semiconductor Corporation in many forms, e.g. as Cypress Semiconductor Corporation's CY8C20x37 product family or as MTCH10x family from Microchip Inc.

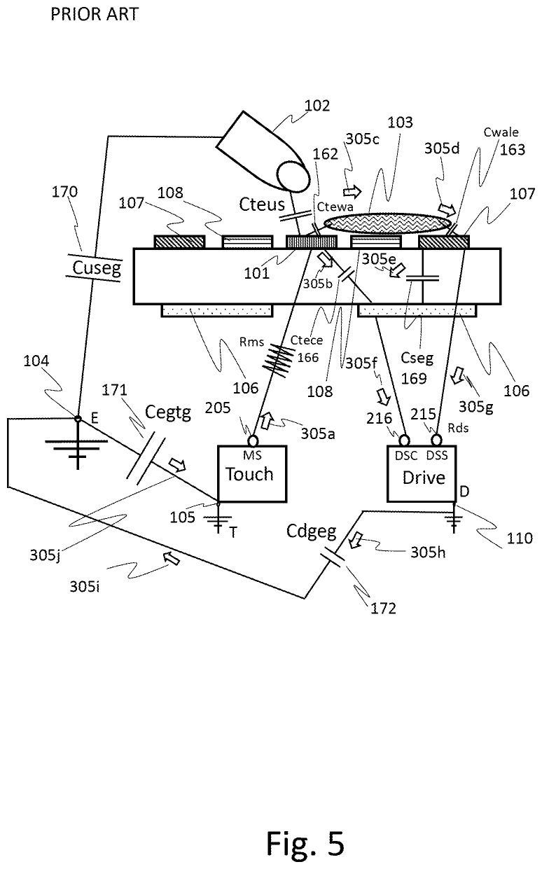

FIG. 5 illustrates yet another challenge of the prior art touch displays. The environmental exposure like a splash of water can be large and cover most or the entire touch display, at least momentarily. This kind of exposure is very detrimental for the correct functioning of the touch display. Thus, the exposure forms a capacitive parasitic bridge or a parasitic series connection also between the touch electrodes 101 and the display light producing electrodes 107. This is illustrated with arrow 305c that lead across capacitance Ctewa (touch electrode—water) 162 to the light producing electrode (specifically, the segment display electrode 107) via capacitance Cwale (water—light electrode) 163, denoted also with arrow 305d, and further across the segment capacitance Cseg to the common display electrode 106 at the other side of the thin film structure, said current path denoted with arrow 305e. Another option for the coupling to light producing electrodes from the touch electrode is via capacitance Ctece, shown with symbol 166, (giving rise to capacitive current branch 305b), which is a capacitance directly between the touch capacitance 101 and the common display electrode 106. This capacitance can grow to be substantial especially if the environmental exposure 103 is at the side of the common display electrodes 106.

The relevant circuit loop with relation to parasitic coupling having an effect on the touch functionality in the presence of an environmental exposure comprises also section between the touch measurement node 205 of the touch electronics to touch electrode 101 (parasitic circuit branch 305a), and the connections denoted with circuit branch 305f between the common display electrode 106 and the common drive node 216 of the drive electronics, capacitance Cdgeg (marked with symbol 172) between the driving electronics ground node 110 and earth ground node 104 (denoted with with arrow 305i), and finally capacitance Cegtg 171 between the earth ground node 104 and the touch ground node 105 (denoted with arrow 305j).

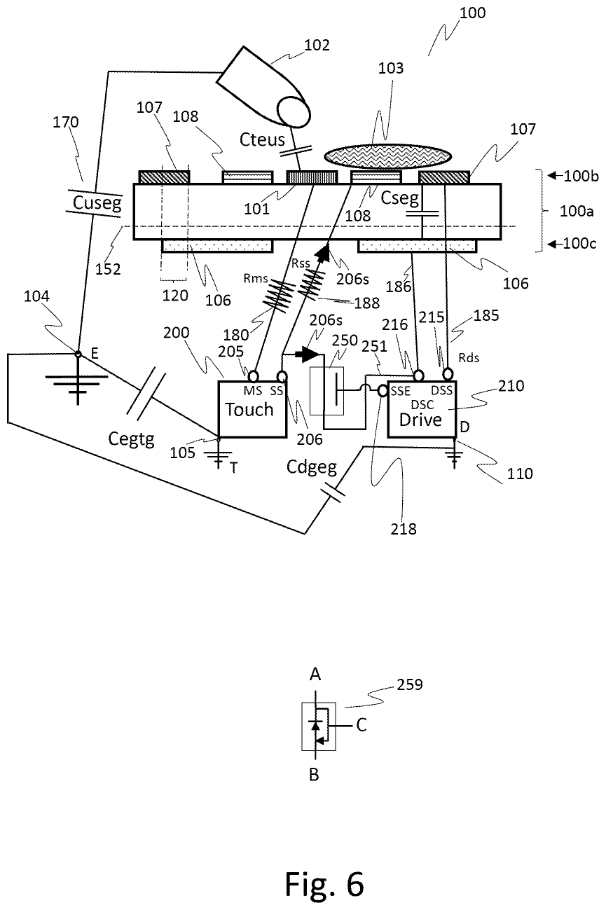

FIG. 6 illustrates an aspect of the present invention. In the figure, there is a schematic diagram of a touch display 100. The touch display 100 comprises a transparent thin film display element 100a extending substantially along a base plane 152 defining a lateral extension of the transparent display element 100a. The plane can be flat or suitably curved, for example to accommodate a curved shape of the interlayer or surface of a car side window or windshield.

The transparent thin film display element 100a comprises an emissive layer 150 arranged to emit light when an excitation voltage is coupled over the emissive layer 150. Emissivity can be achieved with certain doped inorganic materials like manganese doped zinc sulfide (ZnS:Mn) requiring a relatively high, alternating voltage behaviour. Voltage pulse amplitude can be e.g. 195V. Also organic materials can be used, and in this case the emissive layer can comprise a PN junction and operate along the principles of an organic LED (OLED), requiring low voltages (3V-10V) for excitation. The transparent thin film display element 100a comprises also a first patterned conductor layer 100b on a first side of the emissive layer 150. The concept of “patterned” means that the first conductor layer may comprise several geometrical, essentially planar conductor shapes that are not connected to one another, but may form a shape, e.g. a letter or a segment of a seven-segment display, or a fill area or a touch electrode area. Patterns can be arranged e.g. with lithographical methods. In particular, the first patterned conductor layer 100b comprises a segment display electrode 107.

The layer structure also comprises a second patterned conductor layer 100c on a second side of the emissive layer 150 opposite the first side, comprising a common display electrode 106 at least partly laterally overlapping the segment display electrode 107. Overlap of the segment display electrode and common display electrode is shown with symbol 120 in FIG. 6.

Layers of the transparent thin film display element 100a can be arranged on a substrate, e.g. deposited on a transparent soda lime glass substrate with thin film deposition techniques like chemical vapor deposition, atomic layer deposition and/or sputtering.

The touch display 100 comprises also a touch electrode 101. In FIG. 6 the touch electrode 101 is arranged on the same layer as the segment display electrode 107, but this is not the only option, as the touch electrode can also be arranged in another layer, for example in the second patterned conductor layer, or some other layer in close proximity and transparently arranged over the layer structure 100a.

Further, the touch display comprises a driving electronics unit 210 comprising a segment driving node 215 arranged to produce a segment driving signal to the segment display electrode 107, a common driving node 216 arranged to produce a common driving signal to the common display electrode 106, and a driving electronics ground node 110. Driving electronics unit may be provided with one or more integrated circuits, discrete electronic components or any combination thereof.

Still further, the touch display 100 comprises a touch measurement unit 200 comprising a touch measurement node 205 arranged to provide a touch measurement signal for touch detection, a shield signal node 206 arranged to provide a signal to decrease capacitive coupling, and a touch ground node 105. Touch measurement signal can be, for example, a train of voltage pulses at frequency f which is fed to the touch electrode 101, and the capacitance Csensor of the touch electrode relative to its surroundings can be sensed as a change in an equivalent resistance R=1/(f Cₛₑₙₛₒᵣ). The touch measurement unit 200 can e.g. comprise a sigma-delta circuit the functionality of which is well known for those skilled in the art to detect a change in said equivalent resistance.

For connecting the above-mentioned parts together, the touch display 100 also comprises a first electrical conductor 185 arranged to electrically connect the segment display electrode 107 and the segment driving node 215. The first electrical conductor 185 comprises usually, in the context of transparent thin film electroluminescent displays, a series connection of a flat cable or FPC cable starting from the segment driving node 215, a bonding pad area of the flat cable or FPC cable and a trace on the first patterned conductor layer connecting the pad area and the segment display electrode 107. A trace is preferably of the same material as the electrodes, e.g. indium doped tin oxide (ITO) arranged by sputtering.

Likewise, the touch display 100 comprises a second electrical conductor 186 arranged to electrically connect the common display electrode and the common driving node 216. Again, a suitable combination of connectors, bonding pad areas, traces, and flat and FPC cables can be used to arrange the electrical conductor 186.

The touch display 100 comprises a third electrical conductor 180 arranged to electrically connect the touch electrode 101 and the touch measurement node 205. The touch measurement node 205 is arranged to provide the touch measurement signal for touch detection. As above, a suitable combination of connectors, bonding pad areas, traces, and flat and FPC cables can be used to arrange the electrical conductor 180.

The touch display 100 also comprises an earth ground node 104 which acts as the true zero potential reference for the touch display 100 and its electrical units and circuit nodes.

According to an aspect of the present invention, the touch display 100 comprises an electric connection 251 between the shield signal node 206 of the touch measurement unit and a driving circuit node of the driving electronics unit 210 arranged to couple the shielding voltage signal 206s to the driving circuit node. The driving circuit node can be, for example, the driving electronics ground node 110, the segment driving node 215 or the common driving node 216. In FIG. 6, the electric connection 251 is arranged to the common driving node 216. Symbol 206s shows the shielding voltage signal being arranged to the display electronics unit and to the fill area 108. The electric connection 251 enables the feeding of the shielding voltage signal to the display electronics unit. The display electronics unit 210 comprises driving circuit nodes, e.g. one or more common driving nodes 216, one or more segment driving nodes 215 and at least one driving electronics ground node 110. Through the driving circuit nodes, the shielding voltage signal reaches light producing electrodes (that is, the segment display electrodes and common display electrodes) of the thin film display element 100a of the touch display. There, the shielding voltage signal decouples the capacitive series connection of “touch electrode—environmental exposure” and “environmental exposure—light producing electrode” and thus diminishes the capacitive effect of the environmental exposure 103 (like a splash of water), making the real touch of user 102 interacting with the touch electrode 101 detectable.

According to an embodiment, the touch display 100 comprises an electric connection 251 between the shield signal node 206 of the touch measurement unit and a common driving node 216 of the driving electronics unit 210. Common driving node 216 distributes the shielding voltage signal very effectively across the transparent thin film display element 100a as common display electrodes 106 reach most of the areas at the second side of the transparent thin film display element 100a. Thus, common display electrodes effectively distribute the shielding voltage signal to the thin film display element 100a, also to the segment display electrodes 107 and to the side of the first patterned conductor layer 100b owing to a large capacitive coupling though the segment capacitance 169 (Cseg). In other words, the capacitance between the segment display electrodes 107 and common display electrodes 106, capacitance Cseg marked with label 169 is high in comparison to many parasitic capacitances of the touch display 100. Thus, the capacitive effect of the environmental exposure 103 is diminished through the shielding voltage signal fed through common display electrodes 106.

Common driving nodes 216 can be arranged to be connected to one another during touch measurement periods, and thus the connection of the shielding voltage signal to the various common driving nodes is straightforward.

According to another embodiment, the touch display 100 comprises an electric connection 251 between the shield signal node 206 of the touch measurement unit and a segment driving node 215 of the driving electronics unit 210 (this kind of electric connection 251 is not shown in FIG. 6). Segment driving nodes 215 can be arranged to be connected to one another during touch measurement periods, and thus the connection of the shielding voltage signal to the various segment driving nodes is straightforward.

According to another embodiment, the touch display 100 comprises an electric connection 251 between the shield signal node 206 of the touch measurement unit and a driving electronics ground node 110 of the driving electronics unit 210 (this kind of electric connection 251 is not shown in FIG. 6). Owing to the various capacitive parasitic paths, feeding shielding voltage signal to the ground node of the drive electronics is also a way to distribute shielding voltage signal to the thin film display element 100a. As the voltages of the segment driving signals and common driving signals are measured relative to the driving electronics ground node 110, driving electronics ground node 110 is also a driving circuit node.

The driving electronics unit 210 may comprise one or more segment driving nodes 215 that are independently arranged to produce a segment driving signal to one or more the segment display electrodes. Similarly, driving electronics unit 210 may comprise one or more common driving nodes 216 that are independently arranged to produce a common driving signal to one or more the common display electrodes. Driving electronics unit 210 may also comprise one or more common driving electronics ground nodes 110 that are, by the nature of an equipotential ground node, arranged to be connected preferably galvanically to each other to comprise a same ground potential during the operation of the touch display. Generalizing the above mentioned, the driving electronics unit 210 may comprise one or more driving circuit nodes.

Still referring to FIG. 6, the touch display 100 may comprise a switch 250 that is arranged to turn an electric connection 251 between the shield signal node 206 of the touch measurement unit 200 and the driving circuit node, in FIG. 6 the common driving node 216, of the driving electronics unit 210 into an open state during light emission periods, and into a closed state during touch measurement periods. A switch may comprise three terminals A, B and C. The switch may be arranged to operate so that terminals A and B that are connected electrically with a low or practically no resistance between terminals A and B in a closed state (corresponding to an “on” state), and unconnected electrically with a high or practically infinite resistance between the terminals A and B in an open state (corresponding to an “off” state), and further the state of the connection between the terminals A and B is controlled with a terminal C, arranged to be controlled with e.g.

with an electric control signal connected to a control terminal C. In FIG. 6, the terminals A, B and C related to a switch are shown separately in a section 259.

Advantageously, the operation of the touch display 100 is arranged between light emission periods during which light emission from segment and common display electrodes occurs, and touch measurement periods during which touch detection and touch measurement occurs. Light emission periods and touch measurement periods alternate and repeat in time. During touch measurement period, there is at least one period with no light emission. Similarly, during light emission period, there is at least one another period with no touch measurement.

During light emission periods, a segment driving signal is arranged to one or more segment display electrodes and a common driving signal is arranged to one or more common display electrodes, producing light emission from the emissive layer, from the regions where one or more segment display electrodes and one or more common display electrodes overlap. During a touch measurement periods, a touch measurement signal is arranged to the one or more touch electrodes for touch sensing, and the shielding voltage signal is arranged to the one or more driving circuit nodes for increased water immunity.

The switch 250 may comprise e.g. a MOSFET (metal oxide semiconductor field effect transistor) component that can be made conductive or non-conductive between its drain and source terminals by arranging a voltage to the gate terminal that opens up the channel between the drain and source terminals and by arranging a bias voltage to the gate, source and drain nodes to facilitate switching. Any other switching circuit topology well known in the art may also be used. As shown also in FIG. 6, as an embodiment, the driving electronics unit 210 of the touch display 100 may comprise a shield signal enabling node 218 which is electrically connected to the switch 250 and arranged to provide a control signal for controlling the open state and the closed state of the switch 250. In this embodiment, the driving electronics unit 210 acts as a master that determines the timing of the alternating, repeating light emission periods and repeating touch measurement periods. Thus, the driving electronics unit 210 may also govern and control the open/closed state of the switch 250. During the light emission periods, the switch is in the open state. In an open state of the switch 250, the shielding voltage signal cannot propagate from shield signal node 206 to the one or more driving circuit nodes from the shield signal node 206. By the same token, during the touch measurement state, the switch 250 is in a closed state. In the closed state of the switch 250, the shield signal node 206 is coupled to the one or more driving circuit nodes. In all of the embodiments related to FIG. 6, the electric connection 251 between the shield signal node 206 and a driving circuit node can be arranged to the common driving node 216, to the segment driving node 215 or to the driving electronics ground node 110 of the driving circuit nodes.

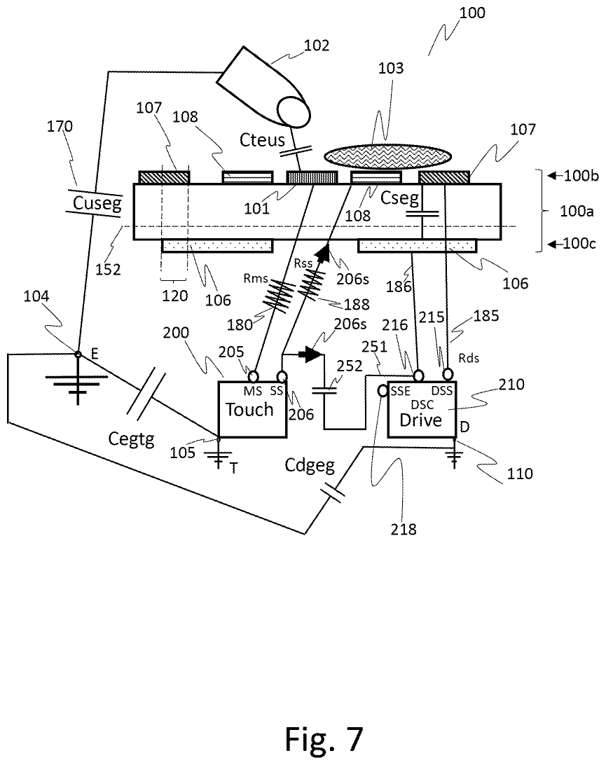

Turning to FIG. 7 and according to an embodiment, the electric connection 251 between the shield signal node 206 and a driving circuit node, here the common driving node 216 comprises a shield signal capacitor 252 with a capacitance of at least 5 pF. As a rule, the shield signal capacitor 252 should be at least ten times the capacitance of Cteus, the touch-electrode-user capacitance 160. This arrangement feeds the shielding voltage signal to electrode structure of the thin film display element 100a, again making the real touch of user 102 interacting with the touch electrode 101 detectable in the presence of an environmental exposure 103. The shield signal capacitor 252 also decouples the segment driving signal and the common driving signal currents from the touch electronics. Substantially large shield signal capacitor 252 pushes the shielding voltage signal of the overall series connection (shield signal capacitor 252 and the other capacitances of the structures in series) to the electrode structure of the display element owing to basic circuit theory and series connection of capacitors. By the same token, the electric connection 251 may comprise a shield signal capacitor 252 with a capacitance 1 pF and 1 uF, more preferably 10 pF and 100 nF, and most preferably 100 pF and 10 nF.

As shown e.g. in FIG. 6 or 7, as an embodiment, the first patterned conductor layer 100b on a first side of the emissive layer 150 of the touch display 100 may comprises a fill area 108, and the touch display 100 may comprise a fourth electrical conductor 188 arranged to electrically connect the fill area 108 and the shield signal node 206 and to couple the shielding voltage signal 206s to the fill area 108.

This arrangement substantially cuts down the false detection of touches as the fill area 108 becomes decoupled from the touch electrodes 101 during the touch measurement periods due to the shielding voltage signal arranged or fed to the fill area 108 through the fourth electrical conductor 188. Again, in FIG. 7, symbol 206s shows the shielding voltage signal being arranged to the display electronics unit and to the fill area 108. In all of the embodiments related to FIG. 7, the electric connection 251 between the shield signal node 206 and a driving circuit node can be arranged to the common driving node 216, to the segment driving node 215 or to the driving electronics ground node 110 of the driving circuit nodes.

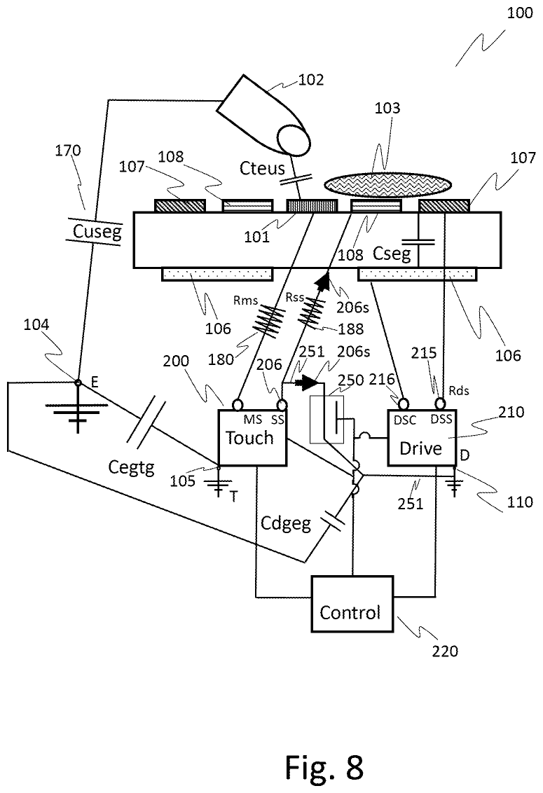

Referring to FIG. 8, according to an embodiment, a touch display 100 comprises a control unit 220 that controls the operation of driving electronics unit, touch measurement unit 200 and the switch 250. The control unit 220 is arranged to control the driving electronics unit 210. The driving electronics unit 210 is arranged, as controlled by the control unit 220, to produce a segment driving signal to the segment display electrode 107 and a common driving signal to the common display electrode 106 for light emission during light emission periods.

The touch measurement unit 200 is arranged, as controlled by the control unit 220, to produce, during touch measurement periods, the touch measurement signal to the touch electrode 101 for touch detection. The touch measurement unit 200 is also arranged, as controlled by the control unit 220, to produce, during touch measurement periods, the shielding voltage signal.

The switch 250, as controlled by the control unit 220, is arranged to electrically connect the shield signal node 206 to the driving circuit node during touch measurement periods. In FIG. 8, the driving circuit node is the driving electronics ground node 110 of the driving electronics unit 210. In other words, the switch 250, as controlled by the control unit 220, may be arranged to electrically connect the shield signal node 206 to the driving electronics ground node 110 during touch measurement periods. However, the switch 250, as controlled by the control unit 220, may also be arranged to electrically connect the shield signal node 206 to the segment driving node 215 or to the common driving node 216.

The switch 250, as controlled by the control unit 220, is also arranged to disconnect the shield signal node 206 from the driving circuit node of the driving electronics unit 210 during light emission periods. As above, in FIG. 8, the driving circuit node is the driving electronics ground node 110 of the driving electronics unit 210. In other words, the switch 250, as controlled by the control unit 220, may be arranged to disconnect the shield signal node 206 from the driving electronics ground node 110 during touch measurement periods. However, the switch 250, as controlled by the control unit 220, may also be arranged to disconnect the shield signal node 206 from the segment driving node 215 or from the common driving node 216. Symbol 206s shows the shielding voltage signal being arranged to the display electronics unit and to the fill area 108. As the thin film structure outside the conducive layers is essentially electrically insulating (dielectric), it is possible to arrange the touch electrodes on either side or on both sides of the emissive layer. In an embodiment, in the touch display 100, the first patterned conductor layer 100b on a first side of the emissive layer 150 comprises a touch electrode 101. In another embodiment, in the touch display 100, the second patterned conductor layer 100c on a second side of the emissive layer 150 comprises a touch electrode (not shown in Figures). In yet another embodiment, in the touch display 100, both the first patterned conductor layer 100b on a first side of the emissive layer 150 and the second patterned conductor layer 100c on a second side of the emissive layer 150 (not shown in Figures) each comprise a touch electrode 101. Naturally, the first patterned conductor layer 100b on a first side of the emissive layer 150 may comprise one or more touch electrodes 101. The second patterned conductor layer 100c on a second side of the emissive layer 150 may also comprises one or more touch electrodes (not shown in Figures). Also both the first patterned conductor layer 100b on a first side of the emissive layer 150 and the second patterned conductor layer 100c on a second side of the emissive layer 150 (not shown in Figures) may comprise one or more touch electrodes 101.

In all of the embodiments related to FIG. 8, the electric connection 251 between the shield signal node 206 and a driving circuit node can be arranged to the common driving node 216, to the segment driving node 215 or to the driving electronics ground node 110 of the driving circuit nodes.

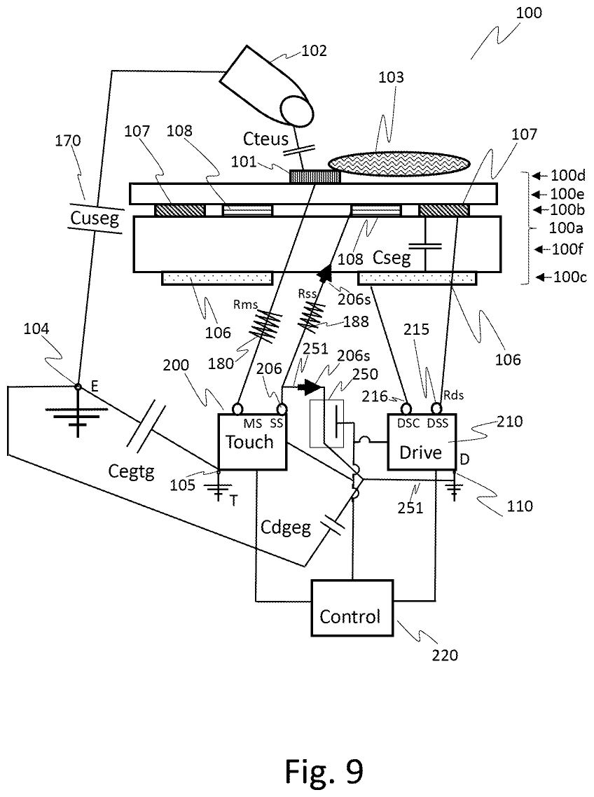

Turning to FIG. 9, as an embodiment, the transparent thin film display element 100a of the touch display 100 comprises a third patterned conductor layer 100d, and the third patterned conductor layer comprises the touch electrode 101. Even though for various mechanical and optical reasons it is advantageous to arrange the touch electrode to the first patterned conductor layer or to the second patterned conductor layer (or both), it is also possible to arrange, for touch electrodes, an dedicated third patterned conductor layer. This is advantageous especially if the routing of the third electrical conductor is challenging due to space constraints on the first or second patterned conductor layer having traces and electrodes related to light emission. The third patterned conductor layer 100d may be arranged over a touch separation substrate 100e which then is added to the light emissive part of the display element e.g. by gluing or bonding. The touch electrodes are then arranged to the third patterned conductor layer 100d similarly as with electrodes in the first conductor layer and second conductor layer. Alternatively, unit 100e is an insulating thin film.

In all of the embodiments related to FIG. 9, the electric connection 251 between the shield signal node 206 and a driving circuit node can be arranged to the common driving node 216, to the segment driving node 215 or to the driving electronics ground node 110 of the driving circuit nodes.

Referring to FIGS. 6-9, as an embodiment, the first patterned conductor layer 100b may comprise one or more segment display electrodes 107. To facilitate their driving, the driving electronics unit 210 may comprise one or more segment driving nodes 215. Similarly, the touch display 100 may comprise one or more first electrical conductors 185 that are arranged to electrically connect the one or more segment display electrodes 107 and the one or more segment driving nodes 215.

Also, the second patterned conductor layer 100c may comprise one or more common display electrodes 106, and to arrange their driving, the driving electronics unit 210 may comprise one or more common driving nodes 216. The touch display 100 may also comprise one or more second electrical conductors 186 arranged to electrically connect the one or more common display electrodes 106 and the one or more common driving nodes 216.

The touch display 100 may also comprise one or more touch electrodes 101. To arrange a measurement signal thereto, the touch measurement unit 200 comprises one or more touch measurement nodes 205 arranged to provide a touch measurement signal for touch detection. To arrange electrical connectivity between the one or more touch electrodes 101 and the one or more touch measurement nodes 205, the touch display 100 may also comprise one or more third electrical conductors 180 arranged to electrically connect the one or more touch electrodes 101 and the one or more touch measurement nodes 205.

The invention has been described above with reference to the examples shown in the figures. However, the invention is in no way restricted to the above examples but may vary within the scope of the claims.

1. A touch display comprising:
a transparent thin film display element extending substantially along a base plane defining a lateral extension of the transparent thin film display element the transparent thin film display element comprising:
an emissive layer arranged to emit light upon an excitation voltage is arranged over the emissive layer,
a first patterned conductor layer on a first side of the emissive layer, first patterned conductor layer comprising a segment display electrode,
a second patterned conductor layer on a second side of the emissive layer opposite the first side of the emissive layer comprising a common display electrode at least partly laterally overlapping the segment display electrode;
the touch display further comprising:
a touch electrode,
a driving electronics unit comprising:
a segment driving node arranged to produce a segment driving signal to the segment display electrode,
a common driving node arranged to produce a common driving signal to the common display electrode,
a driving electronics ground node
a touch measurement unit comprising:
a touch measurement node arranged to provide a touch measurement signal for touch detection,
a shield signal node arranged to provide a shielding voltage signal arranged to decrease capacitive coupling, and
a touch ground node;
the touch display further comprising:
a first electrical conductor arranged to electrically connect the segment display electrode and the segment driving node,
a second electrical conductor arranged to electrically connect the common display electrode and the common driving node,
a third electrical conductor arranged to electrically connect the touch electrode and the touch measurement node, and
an earth ground node;
wherein the touch display comprises
an electric connection between the shield signal node of the touch measurement unit and a driving circuit node of the driving electronics unit arranged to couple the shielding voltage signal to the driving circuit node.

2. A touch display according to claim 1, wherein the touch display comprises the electric connection between
the shield signal node of the touch measurement unit and a common driving node of the driving electronics unit; or
the shield signal node of the touch measurement unit and a segment driving node of the driving electronics unit; or
the shield signal node of the touch measurement unit and a driving electronics ground node of the driving electronics unit.

3. A touch display according to claim 1, wherein
the electric connection comprises a shield signal capacitor; or
the electric connection comprises a shield signal capacitor with a capacitance of at least 5 pF; or
the electric connection comprises a shield signal capacitor
with a capacitance between 1 pF and 1 uF; or
with a capacitance more preferably 10 pF and 100 nF; or
with a capacitance and most preferably 100 pF and 10 nF.

4. A touch display according to claim 1, wherein the touch display comprises a switch that is arranged to turn the electric connection between the shield signal node of the touch measurement unit and the driving circuit node of the driving electronics unit into:
an open state during light emission periods, and
a closed state during touch measurement periods.

5. A touch display according to claim 1, wherein
the first patterned conductor layer on a first side of the emissive layer comprises a fill area, and
the touch display comprises a fourth electrical conductor arranged to electrically connect the fill area and the shield signal node and to couple the shielding voltage signal to the fill area.

6. A touch display according to claim 4, wherein the driving electronics unit comprises a shield signal enabling node which is electrically connected to the switch and arranged to provide a control signal, the control signal arranged to control the open state and the closed state of the switch.

7. A touch display according to claim 4, wherein the touch display comprises a control unit arranged to control:
a) the driving electronics unit, as controlled by the control unit, arranged to produce a driving signal to the segment display electrode and to the common display electrode for light emission during light emission periods;
b) the touch measurement unit, as controlled by the control unit, arranged to produce, during touch measurement periods,
the touch measurement signal to the touch electrode for touch detection, and
the shielding voltage signal; and
c) the switch, as controlled by the control unit arranged to
connect the shield signal node to the driving circuit node of the driving electronics unit during touch measurement periods, and
disconnect the shield signal node from the driving circuit node of the driving electronics unit during light emission periods.

8. A touch display according to claim 1, wherein:
the first patterned conductor layer on a first side of the emissive layer comprises the touch electrode; or
the second patterned conductor layer on a second side of the emissive layer comprises the touch electrode or both.

9. A touch display according to claim 1, wherein the transparent thin film display element comprises a third patterned conductor layer, and the third patterned conductor layer comprises the touch electrode.

10. A touch display according to claims 1 wherein:
the first patterned conductor layer comprises one or more segment display electrodes,
the driving electronics unit comprises one or more segment driving nodes,
and the touch display comprises one or more first electrical conductors arranged to electrically connect the one or more segment display electrodes and the one or more segment driving nodes.

11. A touch display according to claim 1, wherein:
the second patterned conductor layer comprises one or more common display electrodes,
the driving electronics unit comprises one or more common driving nodes,
and the touch display comprises one or more second electrical conductors arranged to electrically connect the one or more common display electrodes and the one or more common driving nodes.

12. A touch display according to claim 1, wherein:
the touch display comprises one or more touch electrodes,
the touch measurement unit comprises one or more touch measurement nodes arranged to provide a touch measurement signal for touch detection, and
the touch display comprises one or more third electrical conductors arranged to electrically connect the one or more touch electrodes and the one or more touch measurement nodes.
